(19) United States
(12) Patent Application Publication
(10) Pub. No.: US 2025/0036959 A1
(43) Pub. Date: Jan. 30, 2025

(54) DISTRIBUTED REWARD DECOMPOSITION FOR REINFORCEMENT LEARNING

(71) Applicant: Telefonaktiebolaget LM Ericsson (publ), Stockholm (SE)

(72) Inventors: Subramanian IYER, San Ramon, CA (US); Ravi PANDYA, El Dorado Hills, CA (US)

(73) Assignee: Telefonaktiebolaget LM Ericsson (publ), Stockholm (SE)

(21) Appl. No.: 18/714,086

(22) PCT Filed: Dec. 1, 2021
(86) PCT No.: PCT/IB2021/061200

§ 371 Date: May 28, 2024

(51) Int. Cl. G06N 3/092; G06N 3/098

(52) U.S. Cl. CPC G06N 3/092; G06N 3/098

(57) ABSTRACT

A method of distributed training of a machine learning model is provided. The method includes inputting a first set of observations and a first set of actions for a primary agent to generate a first Q function for the primary agent, inputting a second set of observations and a second set of actions for a set of secondary agents to generate a set of Q functions for the set of secondary agents, and generating a Qtot function from the first Q function and the set of Q functions by a mixing network for the primary agent, the Qtot function to generate actions or predictions to configure a first node to operate in a telecommunication network.

### TECHNICAL FIELD

Embodiments of the invention relate to the field of telecommunications network management; and more specifically, to the training of reinforcement learning models to improve telecommunication network operations.

### BACKGROUND ART

Machine learning (ML) involves the use of computer executed programs that do not rely on explicit rules or instructions to complete a task. Instead, machine learning models are developed using a training process and training data sets. Machine learning systems generate a ML model based on input training data sets that provide a sample of the types of data to be processed with known correlations or outcomes. The ML model is trained with the training data set to be able to make predictions or decisions without being explicitly programmed to do so when presented with new input data. Machine learning systems can be used in applications that are utilized in a diverse set of fields, such as in medicine, computer security, and audio/visual processing. Machine learning systems can perform well in case where it is difficult to develop conventional algorithms to accurately perform the tasks.

Reinforcement learning (RL) is a type of machine learning. Reinforcement learning employs ‘agents’ also referred to as ‘intelligent agents.’ The agents make decisions to take actions in a given execution environment. The agents make the decisions that maximize the ‘cumulative reward’ amongst the operating agents. In other words, the agents operate to use past experience (i.e., training data sets) to determine which actions lead to higher cumulative rewards for a given set of inputs. The methodology of reinforcement learning is for each agent to learn an optimal, or near optimal, policy that maximizes a ‘reward function’ that accumulates immediate rewards. The ‘policy’ is a modeled mapping that gives a probability or correlation of taking a given action when in a given state.

### SUMMARY

In one embodiment, a method of distributed training of a machine learning model is provided. The method includes inputting a first set of observations and a first set of actions for a primary agent to generate a first Q function for the primary agent, inputting a second set of observations and a second set of actions for a set of secondary agents to generate a set of Q functions for the set of secondary agents, and generating a Qtot function from the first Q function and the set of Q functions by a mixing network for the primary agent, the Qtot function to generate actions or predictions to configure a first node to operate in a telecommunication network.

In a further embodiment, an electronic device can execute the method of distributed training of the machine learning model. The electronic device includes a non-transitory computer-readable storage medium having stored therein a network trainer, and a processor coupled to the non-transitory computer-readable storage medium. The processor can execute the network trainer. The network trainer can input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent, the Qtot function to generate actions or predictions to configure a first node to operate in the telecommunication network.

In another embodiment, a computing device can execute the method in a network. The computing device can execute a plurality of virtual machines. The plurality of virtual machines implementing network function virtualization (NFV). The computing device includes a non-transitory computer-readable storage medium having stored therein a network trainer, and a processor coupled to the non-transitory computer-readable storage medium. The processor can execute one of the plurality of virtual machines. The one of the plurality of virtual machines can execute the network trainer, the network trainer to input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent, the Qtot function to generate actions or predictions to configure a first node to operate in a telecommunication network.

In one embodiment, a control plane device can execute the method in a software defined networking (SDN) network. The control plane device can include a non-transitory computer-readable storage medium having stored therein a network trainer, and a processor coupled to the non-transitory computer-readable storage medium. The processor can execute the network trainer. The network trainer can input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a telecommunications network managed by a distributed reinforcement learning system.

FIG. 2 is a diagram of one embodiment of agents and mixing networks.

FIG. 3 is a flowchart of one embodiment of a process for training the distributed reinforcement learning system.

FIG. 4 is a diagram of one embodiment of cloud implementation of the distributed reinforcement learning system.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straightforward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software 650), according to some embodiments of the invention.

### DETAILED DESCRIPTION

The following description describes methods and apparatus for a distributed reinforcement learning system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Reinforcement learning systems train an agent to perform actions in an environment to maximize a reward. Reinforcement learning can be further expanded to multiagent reinforcement learning problems, where the goal is to train multiple agents to work together to collaboratively maximize a joint reward signal. The multiagent reinforcement learning problem is especially difficult because the optimal actions of one agent can depend on the actions of other agents. One method for multiagent reinforcement learning is referred to as QMIX. QMIX uses a neural network architecture that compartmentalizes the contributions of each agent. QMIX trains decentralized policies in a centralized end-to-end method.

The example embodiments build upon the components of QMIX. However, one skilled in the art would appreciate that other techniques for reinforcement learning can be applied. Other reinforcement learning techniques or methods include relational reward machines, attentive relation state representation in decentralized multiagent reinforcement learning, actor-attention-critic, QTRAN, networked distributed partially observable Markov decision processes (POMDPs), deep coordination graphs, and similar methods and techniques. Relational reward machines involve decomposing a multi agent task into sub-environments for each agent, where each environment only presents the information that agent needs to do its part in the overall task. Attentive relational state representation in decentralized multiagent reinforcement learning trains an agent to coalesce information from a time-variant neighborhood of agents into a fixed size vector, which factors into its action policy. Actor-Attention-Critic involves using separate advantage functions for each agent, where each advantage function is trained to give attention to other agents depending on how relevant that agent is.

QTRAN involves training a set of neural networks in a centralized manner such that each agent ends up with its own neural network that it can use to take actions with decentralized execution. Networked Distributed POMDPs involves considering the array of agents separately and grouping them together in neighborhoods where the neighborhoods are defined according to reward function interactions. Deep Coordination Graphs involves expressing a value function in terms of a utility function, akin to a value function factorization that can be greedily maximized by each agent, and a payoff function, which accounts for pair-wise interactions between agents.

The embodiments overcome the deficiencies of the prior art. One problem with QMIX is that it requires a mixing network for training. This mixing network must take as input the results from all the agent component networks, and during training, must pass along gradient updates to all of the agent component. For large scale systems with many agents, this can quickly become infeasible (i.e., QMIX does not scale well). An issue with relational reward machines is that they require the separate agent environments to be manually built by hand. This would not be feasible in cases where it is not obvious a priori what actions the different agents should take. An issue with attentive relational state representation is that by coalescing information into a fixed size vector, an agent necessarily loses some information which may be relevant for deciding the optimal action. In addition, this technique involves one shared reward function across an entire array of agents and broadcasting this reward to all agents could have bottleneck issues if the array of agents is large.

An issue with Actor-Attention-Critics is that training the array of critics to pay attention only to the relevant agents adds an additional training complexity. Also, this technique involves one shared reward function across an array of agents, introducing potential bottleneck issues if this reward must be broadcast to all agents. An issue with QTRAN is that it involves training all agents in a centralized manner, which becomes infeasible if the number of agents grows large. An issue with Network Distributed POMDPs is that it assumes observational independence between agents, or that the observation of one agent does not give any information about the observation of another agent. This assumption will not be true in general. An issue with deep coordination graphs is that it involves message passing between agents, which could be computationally expensive.

These problem in the art as set forth above are solved by the embodiments. The embodiments break up the mixing network of QMIX into separate components for different groups of agents. While the actions of one agent in QMIX may impact the optimal action of another, it is unlikely that the actions of one agent impacts the optimal actions of all other agents, and instead is only relevant to a small subset of the other agents. In making this change to the operation of QMIX, no mixing network must be overly large, and training in a distributed manner becomes possible.

The main advantage of the embodiments is that it enables training a large ensemble of agents using a deep reinforcement learning approach without having to use a giant neural network (i.e., mixing network) that has to issue feedback to every agent. Thus, the embodiments provide a distributed reinforcement learning process and system that is scalable. In particular, the distributed reinforcement learning process and system of the embodiments is advantageous for use in telecommunication systems. The example embodiments are based on a modification of QMIX to make a distributed version of QMIX that does not have a centralized mixing network, however, one skilled in the art would understand that the embodiments can be applied with other reinforcement learning approaches such as those described herein.

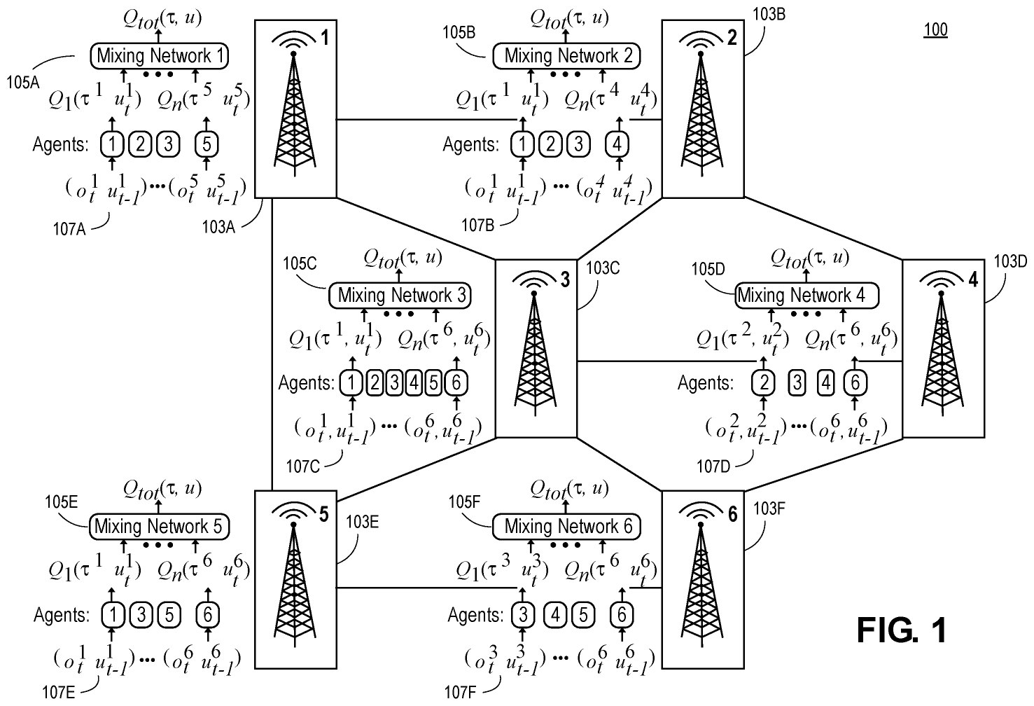

FIG. 1 is a diagram of one embodiment of a telecommunications network implementing distributed reinforcement learning system and process. In the context of managing configuration parameters of cells in a cellular telecommunication network, for example, configuring antenna tilt, where the quality of a set of configuration parameters is determined by an evaluation metric, for example, the average user throughput, the objective of the embodiments is to train an ensemble of agents, each to control one or more parameters of a cell (such as antenna tilt), such that the joint actions across all agents in concert with each other optimize the global evaluation metric (such as average user throughput) across the whole cellular telecommunication network.

In the embodiments, the policy for each agent is determined by a neural network. During training, the output of an agent's network feeds into a mixing network, but there are many mixing networks for the entire ensemble of agents, not just a single centralized mixing network. In one embodiment, every agent a has its own mixing network, and that mixing network takes input, i.e., observations, from networks of all agents that are expected to significantly impact agent a. Each mixing network is trained based on a localized evaluation metric, and in this way, clusters of agents are trained to collaboratively work together to optimize a local reward, with the result being that the entire ensemble of agents gets trained to work in collaboration to optimize for a global reward. Note that this is a decentralized training approach because each mixing network only requires the local reward and feeds back to just a subset of agents that are thought to impact each other.

The embodiments make a tradeoff between computational feasibility and a confirmed global optimality. In one extreme, a process could guarantee global optimality by including all agents in all mixing networks, but this would be computationally infeasible where there are a large number of agents. On the other extreme, each mixing network could only take input from one agent, but this would be very unlikely lead to an optimal solution or even approximate an optimal solution, especially if the interaction between any combination of the agents is significant. By managing a set of mixing networks to take inputs from a subset of the total number of agents that is limited to those that are known to significantly impact each other, the embodiments make a tradeoff between these two extremes, thereby maintaining computational feasibility while also achieving a reasonable solution that approximates a globally optimal solution in most cases.

An advantage of the embodiments over regular QMIX and QTRAN is that the embodiments do not require a single centralized mixing network that takes input from all agents and can therefore scale to a larger number of agents. An advantage over relational reward machines is that the embodiments do not require separate agent environments to be manually constructed. An advantage over attentive relational state representation is that the embodiments do not have the bottlenecking issue that comes from broadcasting information to all agents. An advantage over actor-attention critics is that the embodiments avoid the additional training complexity of learning which agents should have attention. An advantage over network distributed POMDPs is that the embodiments do not assume observational independence between agents. An advantage over deep coordination graphs is that this solution does not require potentially expensive message passing between agents.

In the diagram, an ensemble of agents 107A-F are being trained, where each agent (i.e., one of Agents 1 to N) has a mixing network 105A-F, and where each mixing network (1-6) takes as input the output from component networks that each represent an agent (1-6). Each agent (1-6) determines actions to configure a particular aspect of the respective base station. In this example, each antenna (1-6) and more specifically the tilt or orientation of the antenna (1-6) is managed by the respective agent (1-6) to optimize the signaling of the antenna (1-6) in communicating with user equipment (UEs). Each mixing network (1-6) has a component network representing each agent (1-6) that could potentially impact the action for the mixing network's agent. In the illustrated example of FIG. 1, the first base station and antenna (1) in the network 100 are represented by agent 1, which has mixing network 1. The mixing network 1 for agent 1 also receives as input agent 2, agent 3, and agent 5, which are neighboring base stations and antennas (2, 3, and 5), respectively. These neighboring base stations and antennas have a significant impact of the operation of the first base station and antenna (e.g., due to signal strength and overlapping coverage areas). In contrast, the other base stations, and antennas (4 and 6) do not have a significant impact on the configuration of the first base station (e.g., due to location, orientation, power, technology, or other characteristics), and antenna (1) as represented by agent 1 and trained by mixing network 1.

Each of the base stations and associated antennas (1-6) has a specific mixing network (1-6) 105A-F) and set of input agents 107A-F. In a further example from illustrated network 100, the sixth base station and antenna (6) can be represented by agent 6 and mixing network 6. The sixth base station is proximate to three other base stations and their antennas (3-5). Thus, the mixing network 6 for agent 6 has inputs of agents 3-6 for purposes of training the actions of agent 6. The other base stations, antenna 103A-F, mixing networks 105A-F, and agents 107A-F in the network 100 are similarly arranged and interdependent such that a decentralized set of mixing networks 105A-F and agents 107A-F are trainable and operable in a distributed reinforcement learning system.

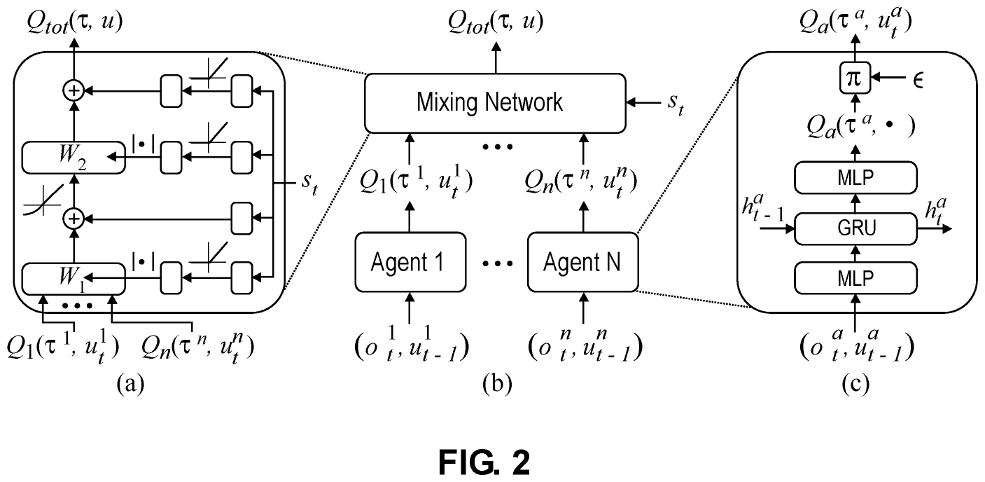

FIG. 2 is a diagram of an example embodiment of a mixing network and agent. For each agent a there is one agent network that represents its individual value function Qa(τ^{a}, u^{u}). QMIX consists of agent networks representing each Qa, and a mixing network that combines them into Qtot. The agent networks are represented as deep recurrent Q networks that make use of recurrent neural networks. The agent networks receive individual observations O^{a}ₜ, and the last action u^{a}ₜ₋₁ as input at each iteration of training. Each agent can further consist of a set of multilayer perceptrons (mlp), and gated recurrent units (GRU) that process the history of the actions of the agent (h^{a}ₜ).

The combination in the mixing network is not a simple sum, rather the combination is a complex nonlinear combination to ensure consistency between policies. In cases where QMIX is utilized, the combination also enforces the constraint of the relation between Qa and Qtot by restricting the mixing network to have positive weights. Hypernetworks are used to condition the weights of the mixing network based on the state, which is observed during training. QMIX can represent complex action-value functions with a factored representation. The mixing network combines the inputs with a set of weights (w_{1,2}) and biases (boxes leading into the weighting). These architectural specifications, elements, and configurations are provided by way of example and not limitation. Those skilled in the art would appreciate that these specifications, elements, and configurations can be modified or differently combined consistent with the principles and structures of the embodiments.

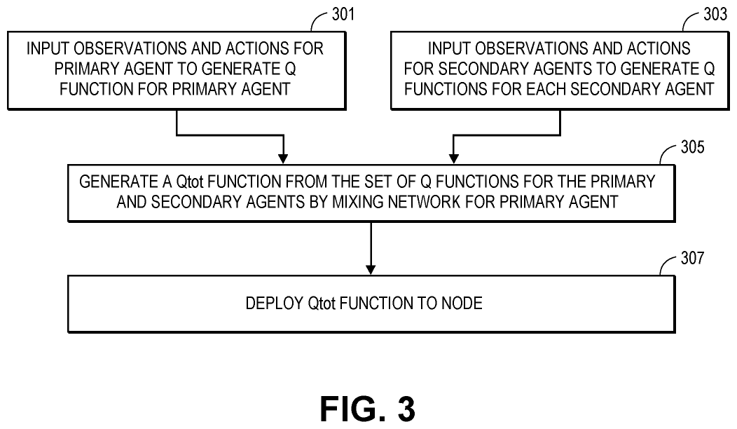

FIG. 3 is a flowchart of one example embodiment of a process for training the distributed reinforcement learning system.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

The distributed reinforcement learning training process can be initiated at an electronic device (e.g., each base station in the cellular network) for each function or aspect to be controlled by an agent managed by or through the electronic device. The distributed reinforcement learning process training at a given node/electronic device is configured with knowledge of the related nodes such that the mixing network for the agent representing the node communicates with the related nodes and receives input from these related nodes. The process can iteratively input observations and actions for the primary agent to generate a Q function for the primary agent (Block 301). The primary agent represents the executing node. The generation of the Q function is based on the prior actions and observations of the agent according to the operation of QMIX as limited by the distributed aspect of the mixing networks (i.e., rather than a single centralized mixing network) as well as the use of the related agents (i.e., rather than all agents) in the network.

The process similarly iteratively inputs observations and actions for each of the secondary agents to generate Q functions for each of the secondary agents (Block 303). Any number of secondary agents can be processed each with respective inputs. The secondary agents correlate with each of the other nodes in the network that affect the primary agent/node. Thus, in the example of FIG. 3, the agent of each antenna/base station is the primary agent and the antenna/base stations that affect the operation of the first antenna/base station are the secondary agents that represent each of the affecting antenna/base stations. The functions of each agent are Qa where a indicates the identity of the agent (e.g., agents 1-6 in the example).

The output of each of the agents (i.e., their respective functions) are input into the mixing network to generate a combined function Qtot (Block 305). The steps of Blocks 301 to 305 can iterate over an input data set continuously updating each of the Q functions (i.e., the Qa and Qtot functions). Once the entire training data set has been ingested, the Q functions have stabilized, or similar endpoint reached, then the Qtot function can be deployed to manage the operation of the associated electronic device (Block 307). The Qtot function can be triggered to generate an action/prediction with each update to the input data in the real-time function of the distributed reinforcement learning to generate actions/predictions to configure the associated electronic device (e.g., the antenna of the base station). While the process has been illustrated for a single agent associated with a single configuration aspect or metric for an electronic device (e.g., antenna tilt), any number of aspects, metrics, configurations can be controlled in a related set of agents at a given electronic device. For example, antenna tilt, transmission power, transmission frequencies, and related metrics and configurations can be correlated and managed by a set of agents for the electronic device in relation to a subset of agents for other electronic devices that are networked or similarly inter-related.

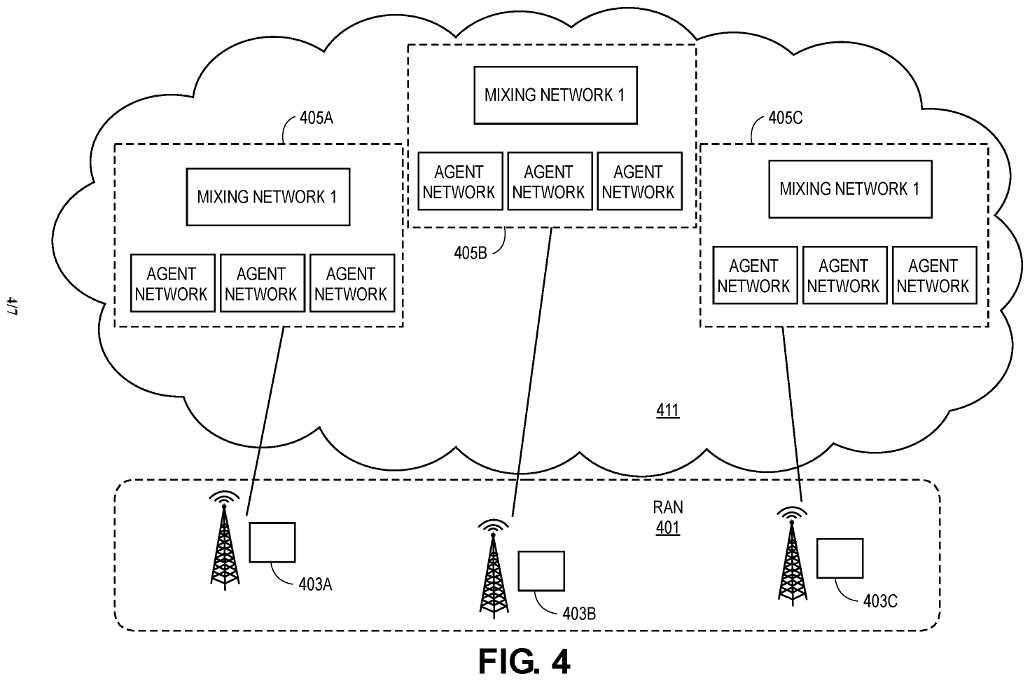

FIG. 4 is a diagram of one embodiment of a cloud infrastructure implementation of the distributed reinforcement learning process and system. The example cloud implementation hosts the distributed reinforcement learning process and system. A cloud computing environment 411 can be any distributed, network, or large scale computing environment. The cloud computing environment 411 can host instances of the distributed reinforcement learning process 405A-C that represent electronic devices or nodes in the distributed reinforcement learning system.

Each of the instances of the distributed reinforcement learning process 405A-C can include a set of agents or agent networks that represent the associated primary node and other secondary nodes that affect the operation of the primary nodes. Thus, the set of agents can include a primary agent representing the primary node and a set of secondary agents that represent the secondary nodes. The cloud computing environment 411 can support any number of distributed reinforcement learning processes 405A-C, which can each include a mixing network and a set of agents where the set of agents can be of any size, but is a subset of the total number of agents in the network being modeled.

In one example, each of the distributed reinforcement learning processes 405A-C represents a node in a telecommunication network such as a radio access network (RAN) 401. The RAN 401 can include a set of base stations 403A-C that have configurable characteristics such as antenna tilt, transmission power, frequencies, and similar characteristics. These configurable characteristics can be optimized by the distributed reinforcement learning processes 405A-C that represent each of the base stations 403A-C (e.g., distributed reinforcement learning process 405A represents base station 403A). In this manner the compute, networking, and storage requirements for the distributed reinforcement learning processes 405A-C can be offloaded from the base stations 403A-C or similar electronic devices to the cloud computing environment 411.

In further embodiments, some of the distributed reinforcement learning processes 405A-C can be executed at the electronic devices that they represent or remote therefrom while other distributed reinforcement learning processes 405A-C can be executed in the cloud or similar remote location. Any combination can be utilized and, in some embodiments, the distributed reinforcement learning processes 405A-C can be executed in containers or similar virtualized environments to enable them to be moved between the cloud or similar compute resources and the represented electronic devices for load and resource balancing and efficiency.

All parts of the distributed reinforcement learning processes 405A-C (e.g., the mixing networks or agents) can be compartmentalized, containerized, or similarly virtualized and executed in the cloud computing environment 411. The cloud computing environment 411 would differ in that the training or determination of actions could happen in the cloud instead of at the local devices 403A-C.

Thus, the embodiments provide a process and system to use many distributed mixing networks instead of just one centralized mixing network for a distributed reinforcement learning process and system, where a given mixing network takes input from a cluster of agents that could impact one another. In this way, the embodiments are able to train an ensemble of agents without the need for an impractically large neural network.

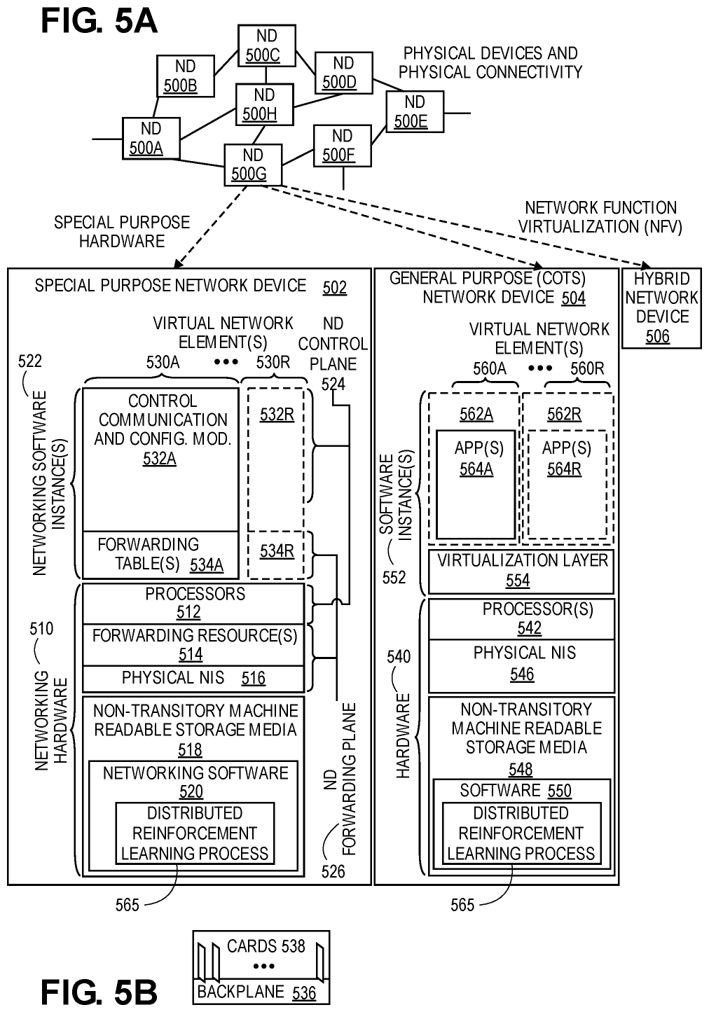

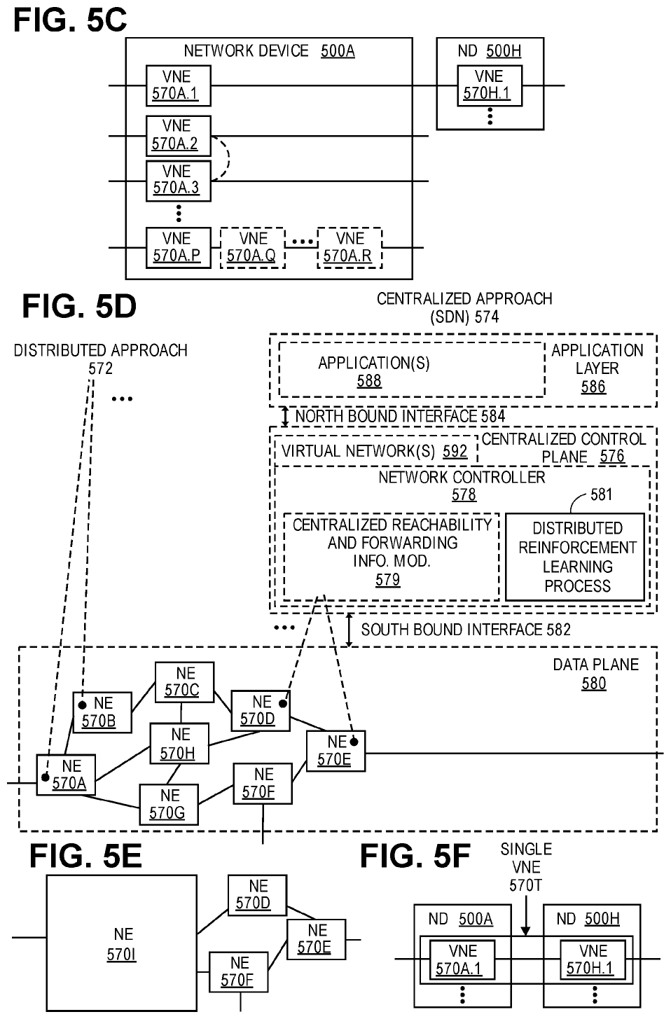

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between 500A-500B, 500B-500C, 500C-500D, 500D-500E, 500E-500F, 500F-500G, and 500A-500G, as well as between 500H and each of 500A, 500C, 500D, and 500G. These NDs are physical devices, and the connectivity between these NDs can be wireless or wired (often referred to as a link). An additional line extending from NDs 500A, 500E, and 500F illustrates that these NDs act as ingress and egress points for the network (and thus, these NDs are sometimes referred to as edge NDs, while the other NDs may be called core NDs).

Two of the exemplary ND implementations in FIG. 5A are: 1) a special-purpose network device 502 that uses custom application-specific integrated-circuits (ASICs) and a special-purpose operating system (OS); and 2) a general purpose network device 504 that uses common off-the-shelf (COTS) processors and a standard OS.

The special-purpose network device 502 includes networking hardware 510 comprising a set of one or more processor(s) 512, forwarding resource(s) 514 (which typically include one or more ASICs and/or network processors), and physical network interfaces (NIs) 516 (through which network connections are made, such as those shown by the connectivity between NDs 500A-H), as well as non-transitory machine readable storage media 518 having stored therein networking software 520. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The networking software 520 can include components of the distributed reinforcement learning processes and system. These components can be stored in the non-transitory machine readable storage media 518 and executed by the compute resources 512.

The special-purpose network device 502 is often physically and/or logically considered to include: 1) a ND control plane 524 (sometimes referred to as a control plane) comprising the processor(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the processor(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and physical NIs 546, as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization. For example, in one such alternative embodiment the virtualization layer 554 represents the kernel of an operating system (or a shim executing on a base operating system) that allows for the creation of multiple instances 562A-R called software containers that may each be used to execute one (or more) of the sets of applications 564A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 554 represents a hypervisor (sometimes referred to as a virtual machine monitor (VMM)) or a hypervisor executing on top of a host operating system, and each of the sets of applications 564A-R is run on top of a guest operating system within an instance 562A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 540, directly on a hypervisor (in which case the unikernel is sometimes described as running within a LibOS virtual machine), or in a software container, embodiments can be implemented fully with unikernels running directly on a hypervisor represented by virtualization layer 554, unikernels running within software containers represented by instances 562A-R, or as a combination of unikernels and the above-described techniques (e.g., unikernels and virtual machines both run directly on a hypervisor, unikernels and sets of applications that are run in different software containers).

The software 550 can include components of the distributed reinforcement learning processes and system. These components can be stored in the non-transitory machine readable storage media 548 and executed by the compute resources 542.

The instantiation of the one or more sets of one or more applications 564A-R, as well as virtualization if implemented, are collectively referred to as software instance(s) 552. Each set of applications 564A-R, corresponding virtualization construct (e.g., instance 562A-R) if implemented, and that part of the hardware 540 that executes them (be it hardware dedicated to that execution and/or time slices of hardware temporally shared), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 562A-R to VNEs also apply to embodiments where such a finer level of granularity and/or unikernels are used.

In certain embodiments, the virtualization layer 554 includes a virtual switch that provides similar forwarding services as a physical Ethernet switch. Specifically, this virtual switch forwards traffic between instances 562A-R and the physical NI(s) 546, as well as optionally between the instances 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also, in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software instances 562A-R may operate as servers; the same would be true for the hybrid network device 506; in the case of the special-purpose network device 502, one or more such servers could also be run on a virtualization layer executed by the processor(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 5D illustrates a network with a single network element on each of the NDs of FIG. 5A, and within this straightforward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 570A-H (e.g., the processor(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the processor(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

The applications 588 or similar layer of the centralized control plane 576 can include components of the distributed reinforcement learning processes and system. These components can be stored in non-transitory machine readable storage media and executed by compute resources of the centralized control plane 576.

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively, or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 570I in one of the virtual network(s) 592 of FIG. 5D, according to some embodiments of the invention. FIG. 5E shows that in this virtual network, the NE 570I is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

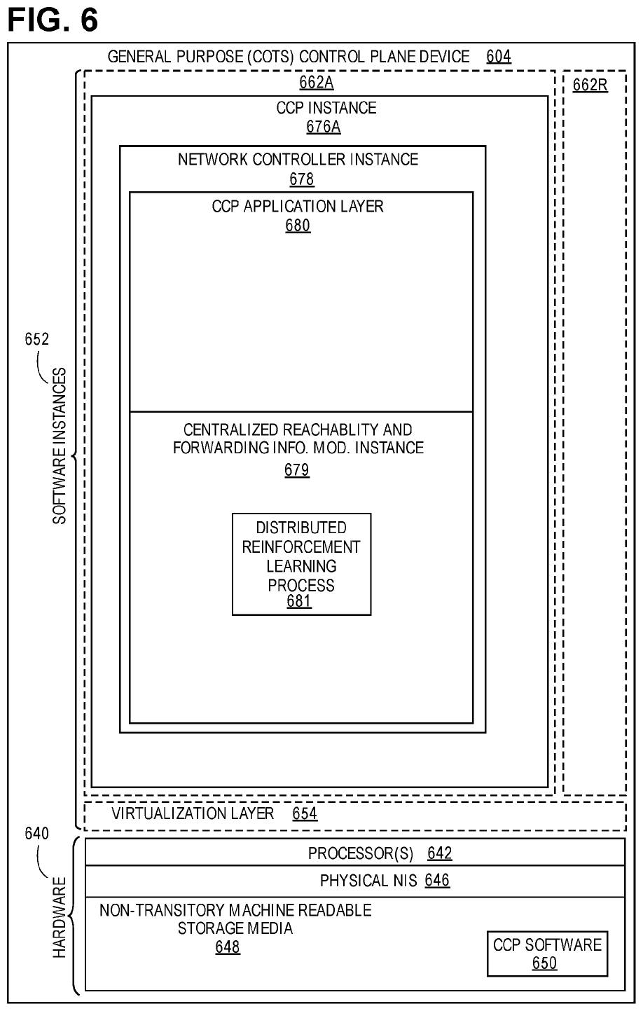

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and physical NIs 646, as well as non-transitory machine readable storage media 648 having stored therein centralized control plane (CCP) software 650.

The software 650 can include components of the distributed reinforcement learning processes and system. These components can be stored in the non-transitory machine readable storage media 648 and executed by the compute resources 642.

In embodiments that use compute virtualization, the processor(s) 642 typically execute software to instantiate a virtualization layer 654 (e.g., in one embodiment the virtualization layer 654 represents the kernel of an operating system (or a shim executing on a base operating system) that allows for the creation of multiple instances 662A-R called software containers (representing separate user spaces and also called virtualization engines, virtual private servers, or jails) that may each be used to execute a set of one or more applications; in another embodiment the virtualization layer 654 represents a hypervisor (sometimes referred to as a virtual machine monitor (VMM)) or a hypervisor executing on top of a host operating system, and an application is run on top of a guest operating system within an instance 662A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 640, directly on a hypervisor represented by virtualization layer 654 (in which case the unikernel is sometimes described as running within a LibOS virtual machine), or in a software container represented by one of instances 662A-R). Again, in embodiments where compute virtualization is used, during operation an instance of the CCP software 650 (illustrated as CCP instance 676A) is executed (e.g., within the instance 662A) on the virtualization layer 654. In embodiments where compute virtualization is not used, the CCP instance 676A is executed, as a unikernel or on top of a host operating system, on the “bare metal” general purpose control plane device 604. The instantiation of the CCP instance 676A, as well as the virtualization layer 654 and instances 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user-interfaces). At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of distributed training of a machine learning model, the method comprising:
inputting a first set of observations and a first set of actions for a primary agent to generate a first Q function for the primary agent;
inputting a second set of observations and a second set of actions for a set of secondary agents to generate a set of Q functions for the set of secondary agents; and
generating a Qtot function from the first Q function and the set of Q functions by a mixing network for the primary agent, the Qtot function to generate actions or predictions to configure a first node to operate in a telecommunication network.

2. The method of claim 1, further comprising:
deploying the Qtot function to the first node in the telecommunication network to manage actions of the first node.

3. The method of claim 2, wherein the primary agent represents the first node in a telecommunications network.

4. The method of claim 3, wherein the secondary agents represent a set of nodes in the telecommunication network that affect-the operation of the first node.

5. The method of claim 1, wherein each of the secondary agents has a respective mixing network to determine a respective Qtot function for each of the secondary agents.

6. An electronic device to execute distributed training of a machine learning model, the electronic device comprising:
a non-transitory computer-readable storage medium having stored therein a network trainer; and
a processor coupled to the non-transitory computer-readable storage medium, the processor to execute the network trainer, the network trainer to input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent, the Qtot function to generate actions or predictions to configure a first node to operate in a telecommunication network.

7. The electronic device of claim 6, wherein the network trainer is further to deploy the Qtot function to the first node in the telecommunication network to manage actions of the first node.

8. The electronic device of claim 7, wherein the primary agent represents the first node in the telecommunication network.

9. The electronic device of claim 8, wherein the set of secondary agents represent a set of nodes in the telecommunication network that affect an operation of the first node.

10. The electronic device of claim 6, wherein each of the secondary agents has a respective mixing network to determine a respective Qtot function for each of the secondary agents.

11. A computing device to execute distributed training of a machine learning model, the computing device to execute a plurality of virtual machines, the plurality of virtual machines implementing network function virtualization (NFV), the computing device comprising:
a non-transitory computer-readable storage medium having stored therein a network trainer; and
a processor coupled to the non-transitory computer-readable storage medium, the processor to execute one of the plurality of virtual machines, the one of the plurality of virtual machines to execute the network trainer, the network trainer to input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent, the Qtot function to generate actions or predictions to configure a first node to operate in a telecommunication network.

12. The computing device of claim 11, wherein the network trainer is further to deploy the Qtot function to the first node in the telecommunication network to manage actions of the first node.

13. The computing device of claim 12, wherein the primary agent represents the first node in the telecommunication network.

14. The computing device of claim 13, wherein the secondary agents represent a set of nodes in the telecommunication network that affect operation of the first node.

15. The computing device of claim 11, wherein each of the secondary agents has a respective mixing network to determine a respective Qtot function for each of the secondary agents.

16. A control plane device to execute a distributed training of a machine learning model in a software defined networking (SDN) network, the control plane device comprising:
a non-transitory computer-readable storage medium having stored therein a network trainer; and
a processor coupled to the non-transitory computer-readable storage medium, the processor to execute the network trainer, the network trainer to input a first set of observations and a first set of actions for a primary agent to generate a first Q function for the primary agent, input a second set of observations and a second set of actions for a set of secondary agents to generate a set of Q functions for the set of secondary agents, and generate a Qtot function from the first Q function and the set of Q functions by a mixing network for the primary agent, the Qtot function to generate actions or predictions to configure a first node to operate in a telecommunication network managed by the SDN network.

17. The control plane device of claim 16, wherein the network trainer is further to deploy the Qtot function to the first node in the telecommunication network to manage actions of the first node.

18. The control plane device of claim 17, wherein the primary agent represents the first node in the telecommunication network.

19. The control plane device of claim 18, wherein the secondary agents represent a set of nodes in the telecommunication network that affect an operation of the first node.

20. The control plane device of claim 16, wherein each of the secondary agents has a respective mixing network to determine a respective Qtot function for each of the secondary agents.
